(19) United States
(12) Patent Application Publication
(10) Pub. No.: US 2024/0420883 A1
(43) Pub. Date: Dec. 19, 2024

(54) WINDING BODY, HIGH-VOLTAGE WINDING, AND DRY-TYPE TRANSFORMER

(71) Applicant: JIANGSU SHEMAR ELECTRIC CO., LTD., Nantong (CN)

(72) Inventors: Bin MA, Nantong (CN); Xinxin ZHANG, Nantong (CN); Tingting MA, Nantong (CN); Chao LIU, Nantong (CN); Xiaorong ZHANG, Nantong (CN)

(73) Assignee: JIANGSU SHEMAR ELECTRIC CO., LTD., Nantong (CN)

(21) Appl. No.: 18/697,607

(22) PCT Filed: Dec. 28, 2022
(86) PCT No.: PCT/CN2022/142721

§ 371 Date: Apr. 1, 2024

(30) Foreign Application Priority Data
Dec. 29, 2021 (CN) 202111644185.6
Dec. 29, 2021 (CN) 202111647922.8

(51) Int. Cl. H01F 27/30; H01F 27/26; H01F 27/32

(52) U.S. Cl. CPC H01F 27/306; H01F 27/323; H01F 27/266

(57) ABSTRACT

A winding body (1310) for a high-voltage winding (130) includes: a plurality of winding plates (1313), each of the winding plates (1313) being provided with a plurality of winding grooves (1314) to form a plurality of comb teeth on the winding plate (1313); and at least one auxiliary member (5316), the auxiliary member (5316) being ring-shaped, the winding plates (1313) being arranged along a circumferential direction of the auxiliary member (5316), and the auxiliary member (5316) being fixedly connected to the winding plates (1313). A high-voltage winding (130) includes: the foregoing winding body (1310); a high-voltage coil (1320); and a high-voltage insulating layer (1330). A dry-type transformer (10) includes a core (110), a low-voltage winding (120), and the foregoing high-voltage winding (130). The low-voltage winding (120) is sleeved outside the core (110), and the high-voltage winding (130) is sleeved outside the low-voltage winding (120).

### CROSS-REFERENCES TO RELATED APPLICATIONS

This application is an U.S. national phase application under 35 U.S.C. § 371 based upon international patent application No. PCT/CN2022/142721, filed on Dec. 28, 2022, which itself claims priority to Chinese patent application No. 2021116441856, filed on Dec. 29, 2021, and Chinese Patent Application No. 2021116479228, filed on Dec. 29, 2021. The contents of the above identified applications are hereby incorporated herein in their entireties by reference.

### TECHNICAL FIELD

The present disclosure relates to the field of power transformer technologies, and in particular, to a winding body, a high-voltage winding including the winding body, and a dry-type transformer including the high-voltage winding.

### BACKGROUND

At present, transformers may be classified into: oil-immersed type transformers, dry-type transformers, and gas-filled type transformers. The dry-type transformers have advantages such as no oil, fire prevention, long service life, energy saving and low noise, simple maintenance, safety, and reliability. At present, most of the dry-type transformers on the market are dry-type transformers including high-voltage windings cast with resin and open dry-type transformers. Although the dry-type transformers have made great progress in the past 10 years, there are still problems such as insulation cracking, poor heat conduction, and harsh operating environments during the operation.

Especially for structures of high-voltage windings of the dry-type transformers, during winding of wires in current high-voltage windings, the wires are all directly wound on tools to form high-voltage coils, and then cast to form high-voltage windings, resulting in poor heat dissipation and short-circuit impact resistance of the high-voltage coils.

### SUMMARY

With respect to the deficiencies in the prior art, the present disclosure is intended to provide a winding body of a high-voltage winding, a high-voltage winding including the winding body, and a dry-type transformer including the high-voltage winding. The winding body of a high-voltage winding, the high-voltage winding including the winding body, and the dry-type transformer including the high-voltage winding according to the present disclosure have advantages such as good fire resistance, aging resistance, and short circuit resistance; recyclable coil, low energy consumption, and energy conservation and environment protection; and stable insulating layer, good mechanical performance and long service life.

According to an aspect of the present disclosure, a winding body for a high-voltage winding is provided, the winding body including: a plurality of winding plates, each of the winding plates being provided with a plurality of winding grooves to form a plurality of comb teeth on the winding plate; and at least one auxiliary member, the auxiliary member being ring-shaped, the winding plates being arranged along a circumferential direction of the auxiliary member, and the auxiliary member being fixedly connected to the winding plates.

In an embodiment, a height of the comb tooth along a length direction of the winding plate is defined as a tooth height, and tooth heights of the comb teeth in the middle of the winding plate and tooth heights of the comb teeth at two ends of the winding plate are both greater than tooth heights of the comb teeth in other parts of the winding plates.

In an embodiment, the winding body further includes a supporting barrel, the supporting barrel being a hollow column. The winding plates are circumferentially evenly distributed on an outer peripheral surface of the supporting barrel, and a length direction of each of the winding plates is arranged along an axial direction of the supporting barrel.

In an embodiment, a first high comb-tooth region, a first low comb-tooth region, a second high comb-tooth region, a second low comb-tooth region, and a third high comb-tooth region are sequentially formed on the winding plate from an end of the winding plate to the other end of the winding plate in the length direction of the winding plate. The first high comb-tooth region and the third high comb-tooth region are arranged symmetrically with respect to the second high comb-tooth region, and the first low comb-tooth region and the second low comb-tooth region are arranged symmetrically with respect to the second high comb-tooth region.

In an embodiment, the auxiliary member is located on the outer peripheral surface of the supporting barrel, and the auxiliary member extends outward along a radial direction of the supporting barrel and surrounds the supporting barrel to form a ring-shaped.

In an embodiment, the plurality of winding plates or the auxiliary member is provided with a slot, and the winding plates and the auxiliary member are clamped and connected through the slot.

In an embodiment, the auxiliary member includes a middle auxiliary member, and the middle auxiliary member is arranged on inner walls of the winding plates.

In an embodiment, the auxiliary member includes an end-portion auxiliary member, and the end-portion auxiliary member is arranged on an outer side of an end portion of the winding plate.

In an embodiment, the winding body is made of a fiber-reinforced composite material.

In an embodiment, each of two ends of the winding plate is provided with a flow groove.

In an embodiment, a plurality of auxiliary members is provided, the auxiliary members are spaced apart in an axial direction of the auxiliary member.

According to another aspect of the present disclosure, a high-voltage winding is provided, the high-voltage winding includes: the winding body in any one of the foregoing embodiments; a high-voltage coil; and a high-voltage insulating layer. A wire is wound on the winding body to form the high-voltage coil, and the high-voltage coil is wholly wrapped with the high-voltage insulating layer.

In an embodiment, the wire includes a first wire and a second wire, the first wire is wound from an end of the winding body to a middle of the winding body along a length direction of the winding plate, and the second wire is wound from the middle of the winding body to the other end of the winding body along the length direction of the winding plate.

In an embodiment, the high-voltage insulating layer fills a gap between the high-voltage coil and the winding body and is wrapped around two ends of the winding body, and the high-voltage insulating layer is injection-molded silicone rubber.

In an embodiment, the injection-molded silicone rubber is high-temperature vulcanized silicone rubber or liquid silicone rubber for injection.

In an embodiment, the high-voltage coil includes a plurality of coil sections, the wire is wound in the winding grooves to cause the plurality of coil sections to be spaced apart along an axial direction of the high-voltage winding, and at least one of the coil sections is arranged between two adjacent comb teeth on the winding plate.

In an embodiment, each of the coil sections is reciprocally wound in layers along the axial direction of the high-voltage winding and is densely arranged on an outer peripheral surface of the winding body.

In an embodiment, the coil section is provided with at least one interlayer insulating layer along the axial direction of the high-voltage winding, and the interlayer insulating layer is an insulating long strip with wavy edges.

According to another aspect of the present disclosure, a dry-type transformer is provided, the dry-type transformer includes: a core, a low-voltage winding, and the high-voltage winding according to any one of the foregoing embodiments, the low-voltage winding is sleeved outside the core, and the high-voltage winding is sleeved outside the low-voltage winding.

In an embodiment, the core is provided with four core clamps at an outer side of the core, and the core clamps are made of fiber-reinforced composite materials.

In an embodiment, the core clamps are compression-molded or pultruded from fiber materials impregnated with epoxy resin.

In an embodiment, the low-voltage winding includes a copper coil and a low-voltage insulating layer, the copper coil and the low-voltage insulating layer are alternately arranged.

In an embodiment, the low-voltage insulating layer is made of a SHS-P diphenyl ether prepreg material or a silicone rubber film.

In an embodiment, the low-voltage winding is provided with at least one heat dissipation air duct, and the heat dissipation air duct is located between the copper coil and the low-voltage insulating layer.

### BRIEF DESCRIPTION OF THE DRAWINGS

According to a more specific description of preferred embodiments of the present disclosure shown in the accompanying drawings, the foregoing objectives, other objectives, features, and advantages of the present disclosure will be clearer. In all the accompanying drawings, a same reference numeral denotes a same part. The drawings are not deliberately drawn to scale according to an actual size and the like, and a focus lies in highlighting the subject of the present disclosure.

Other features, objectives, and advantages of the present disclosure will become more apparent by reading the detailed description of non-limiting embodiments made with reference to the following accompanying drawings.

FIG. 1 is a front view of a dry-type transformer according to an embodiment of the present disclosure;

FIG. 2 is a top view of the dry-type transformer according to an embodiment of the present disclosure;

FIG. 3 is a front view of an assembled core according to an embodiment of the present disclosure;

FIG. 4 is an enlarged view of an area G in FIG. 2;

FIG. 5 is a front view of a core clamp according to an embodiment of the present disclosure;

FIG. 6 is a side view of the core clamp according to an embodiment of the present disclosure;

FIG. 7 is a front view of the dry-type transformer according to an embodiment of the present disclosure;

FIG. 8 is a side view of the dry-type transformer according to an embodiment of the present disclosure;

FIG. 9 is a side view of a lower clamp according to an embodiment of the present disclosure;

FIG. 10 is a schematic perspective view of a winding body according to an embodiment of the present disclosure;

FIG. 11 is a sectional view of a supporting barrel according to an embodiment of the present disclosure;

FIG. 12 is a schematic perspective view of a high-voltage coil wound on the winding body according to an embodiment of the present disclosure;

FIG. 13 is a schematic perspective view of a high-voltage winding according to an embodiment of the present disclosure;

FIG. 14 is a schematic perspective view of a tooling connector according to an embodiment of the present disclosure;

FIG. 15 is a circuit diagram of the high-voltage coil according to an embodiment of the present disclosure;

FIG. 16 is a partial sectional view of the high-voltage winding according to an embodiment of the present disclosure;

FIG. 17 is a partial sectional view of the high-voltage winding according to an embodiment of the present disclosure;

FIG. 18 is a partial sectional view of the high-voltage winding according to an embodiment of the present disclosure;

FIG. 19 is a partial sectional view of the high-voltage winding according to an embodiment of the present disclosure;

FIG. 20 is a schematic perspective view of the winding body according to an embodiment of the present disclosure;

FIG. 21 is an enlarged view of an area H in FIG. 20;

FIG. 22 is a schematic perspective view of the supporting barrel according to an embodiment of the present disclosure;

FIG. 23 is an enlarged view of an area J in FIG. 22;

FIG. 24 is a schematic perspective view of a winding portion according to an embodiment of the present disclosure;

FIG. 25 is a schematic perspective view of an auxiliary member according to an embodiment of the present disclosure;

FIG. 26 is a schematic perspective view of the high-voltage winding according to an embodiment of the present disclosure;

FIG. 27 is a schematic perspective view showing that the high-voltage coil is wound on the winding portion according to an embodiment of the present disclosure;

FIG. 28 is a schematic perspective view showing that the winding portion is connected to the auxiliary member according to an embodiment of the present disclosure;

FIG. 29 is a schematic enlarged view of a part where the winding portion is fixed to an end-portion auxiliary member in FIG. 28;

FIG. 30 is a schematic enlarged view of a part where the winding portion is fixed to a middle auxiliary member in FIG. 28; and

FIG. 31 is a schematic perspective view of the high-voltage winding according to an embodiment of the present disclosure.

### DETAILED DESCRIPTION OF THE EMBODIMENTS

Specific embodiments of the present disclosure are disclosed herein as required. However, it is to be understood that the embodiments disclosed herein are merely typical examples of the present disclosure, which may be embodied in various forms. Therefore, specific details disclosed herein are not to be interpreted as limiting, but merely as a basis for the claims and as a representative basis for teaching those skilled in the art to differently employ the present disclosure in any appropriate manner in practice, including employing various features disclosed herein in combination with features that might not be explicitly disclosed herein.

The term “connect” as referred to in the present disclosure should be understood in a broad sense unless otherwise clearly stipulated or limited, which may be a direct connection or a connection through an intermediary. In the description of the present disclosure, it is to be understood that the orientation or position relationships indicated by the terms “upper”, “lower”, “end portion”, “an end”, and the like are based on the orientation or position relationships shown in the accompanying drawings and are intended to facilitate the description of the present disclosure and simplify the description only, rather than indicating or implying that the apparatus or element referred to must have a particular orientation or be constructed and operated in a particular orientation, and therefore are not to be interpreted as limiting the present disclosure.

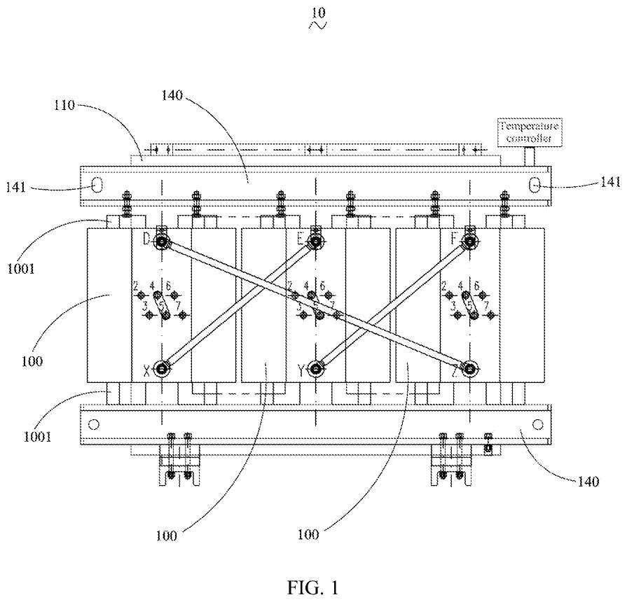

As shown in FIGS. 1 to 3, in an embodiment according to the present disclosure, a dry-type transformer 10 is a three-phase transformer, including a phase A, a phase B, and a phase C. That is, the dry-type transformer 10 includes three single-phase transformers 100. According to a structure of a core 110, the three transformers 100 may be arranged to form a linear structure or a triangular structure, and the three transformers 100 are arranged to form a symmetrical structure. In addition, the dry-type transformer 10 may also be an isolation transformer, a variable frequency transformer, a testing transformer, or the like.

Still referring to FIGS. 1 to 3, in an embodiment according to the present disclosure, the three transformers 100 are arranged to form a linear structure, and the dry-type transformer 10 includes a core 110, three low-voltage windings 120, and three high-voltage windings 130. The core 110, the low-voltage windings 120, and the high-voltage windings 130 are arranged sequentially from inside to outside. Specifically, the core 110 includes three columnar core bodies 111, an upper yoke 112 located at upper ends of the three columnar core bodies 111, and a lower yoke 113 located at lower ends of the three columnar core bodies 111. One low-voltage winding 120 is sleeved on a periphery of each columnar core body 111, and one high-voltage winding 130 is sleeved on a periphery of each low-voltage winding 120. That is, one low-voltage winding 120 and one high-voltage winding 130 are sequentially sleeved on each columnar core body 111 from inside to outside. The core 110, the low-voltage windings 120, and the high-voltage windings 130 are arranged coaxially. That is, the three have a same axial direction. The columnar core bodies 111 are formed by binding and fixing superimposed multi-layer silicon steel sheets with cable ties. Alternatively, radial sections of the columnar core bodies 111 are roughly elliptical or circular or in other shapes. Suitable shapes may be selected for the radial sections of the columnar core bodies 111 according to an actual requirement, provided that the columnar core bodies 111 can be accommodated in hollow cavities of the low-voltage windings 120, which is not limited in the present disclosure. Similarly, the upper yoke 112 and the lower yoke 113 are also formed by superimposed multi-layer silicon steel sheets. The three columnar core bodies 111 are fixedly connected through the upper yoke 112 and the lower yoke 113 to form the core 110.

In an embodiment according to the present disclosure, a simple method for assembling the core 110, the low-voltage windings 120, and the high-voltage windings 130 is provided. Specifically, firstly, the lower yoke 113 of the core 110 is formed by superimposing multi-layer silicon steel sheets and arranged at a bottom of the dry-type transformer 10. Then, multi-layer silicon steel sheets are inserted at two ends of and a middle of the lower yoke 113 respectively to form the three columnar core bodies 111. Next, the low-voltage windings 120 and the high-voltage windings 130 are sequentially sleeved on a periphery of each of the three columnar core bodies 111 from inside to outside. Finally, the multi-layer silicon steel sheets are horizontally inserted at upper ends of the three columnar core bodies 111 to form the upper yoke 112. So far, the core 110, the low-voltage windings 120, and the high-voltage windings 130 are assembled.

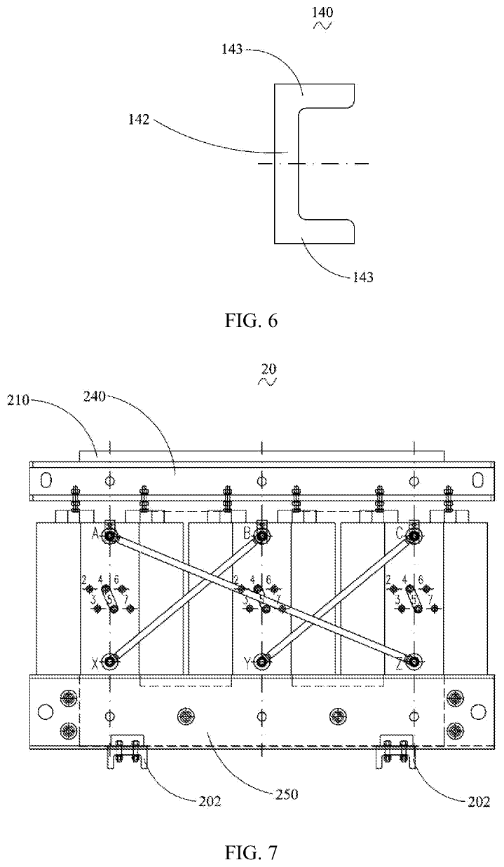

Referring to FIGS. 1, 2, 5, and 6 together, an outer side of the core 110 is provided with a core clamp 140. The core clamp 140 is configured to clamp the core 110. The core clamp 140 is formed by connecting three clamps. All the three clamps are plates, the clamp in the middle is defined as a first clamp 142, and the remaining two clamps are defined as second clamps 143. The two second clamps 143 extend in a same direction on two sides of the first clamp 142 connected to the two second clamps 143, so that the core clamp 140 has a structure similar to channel steel. That is, the core clamp 140 has a “C”-shaped structure. Preferably, the second clamps 143 are arranged perpendicular to the first clamp 142. The first clamp 142 is configured to closely fit the core 110, and the second clamps 143 extend away from the core 110. After the core clamp 140 is mounted, a plate surface of the first clamp 142 is arranged along an axial direction of the core 110, and plate surfaces of the second clamps 143 are arranged along a radial direction of the core 110. Specifically, in an embodiment according to the present disclosure, the axial direction of the core 110 is a vertical direction, and the radial direction of the core 110 is a horizontal direction. Alternatively, in other embodiments, the core clamp may also be a rectangular hollow pipe. That is, the core clamp has a closed structure formed by interconnecting and enclosing four clamps with plate structures. The closed structure makes a structure of the core clamp more stable. Alternatively, the core clamp may have a closed structure interconnecting and enclosing five, six, or more clamps with plate structures, which is not limited herein.

In an embodiment according to the present disclosure, four core clamps 140 are provided, and two of the four core clamps 140 are symmetrically arranged on two sides of an upper end of the core 110 and are fixedly connected through a first fastener to clamp the upper end of the core 110 (i.e., the upper yoke 112). The other two of the four core clamps 140 are symmetrically arranged on two sides of a lower end of the core 110 and are fixedly connected through a second fastener to clamp the lower end of the core 110 (i.e., the lower yoke 113). Preferably, both the first fastener and the second fastener adopt a plurality of screws and bolts used in conjunction with each other, so that two ends of the core 110 are clamped through the two core clamps 140 respectively. Two ends of the core clamps 140 are both provided with first through holes 141. Specifically, two ends of the first clamp 142 are each provided with one first through hole 141. The two core clamps 140 are correspondingly placed on the two sides of the upper end of the core 110, and a screw rod (not shown in figures) is inserted into the two first through holes 141 at a same end of the two core clamps 140, and then the two core clamps 140 are fixed by tightening a bolt. The two ends of the two core clamps 140 are both fixed in this manner, so that the two core clamps 140 clamp the upper end of the core 110. The two core clamps 140 at the lower end of the core 110 are also fixed and clamp the lower end of the core 110 in the same manner. Details are not described again. Alternatively, in order to further reliably clamp the core 110, middle parts of the core clamps 140 may also adopt a plurality of screws and bolts used in conjunction with each other to clamp the middle of the core 110. The second clamps 143 are further provided with second through holes (not shown in figures) to be connected to the low-voltage windings 120.

In this embodiment, the two core clamps 140 at the upper end are located above the high-voltage windings 130 arranged on the periphery of the core 110. Tops of the high-voltage windings 130 are provided with a plurality of insulating pads 1001 for supporting the two core clamps 140 at the upper end and keeping the low-voltage windings 120 and the high-voltage windings 130 at a safe electrical distance from the upper yoke 112 respectively. Similarly, the two core clamps 140 at the lower end are located below the high-voltage windings 130 arranged on the periphery of the core 110. Tops of the two core clamps 140 at the lower end are also provided with a plurality of insulating pads 1001 for supporting the low-voltage windings 120 and the high-voltage windings 130 and keeping the low-voltage windings 120 and the high-voltage windings 130 at a safe electrical distance from the lower yoke 113 respectively. Alternatively, the insulating pads 1001 are made of insulating materials, for example, low shrinkage unsaturated polyester glass fiber-reinforced molding compounds such as dough molding compounds (DMCs) and sheet molding compounds (SMCs), or are molded, for example, by casting with epoxy resin.

The core clamps 140 are made of fiber-reinforced composite materials. Specifically, the core clamps 140 may be compression-molded from glass fibers impregnated with epoxy resin or from aramid fibers impregnated with epoxy resin. Alternatively, the core clamps 140 may also be made of other composite materials. Alternatively, the first clamp 142 and the second clamps 143 are integrally formed.

The fiber-reinforced composite materials refer to composite materials formed by reinforced fiber materials, such as glass fibers or aramid fibers, and matrix materials through a molding process such as winding, molding, or pultrusion.

Alternatively, in other embodiments of the present disclosure, the core clamps may also be made of metal materials. For example, the first clamp and the second clamps may be different sidewalls of a channel steel integrally formed, or may be separately formed and then connected and fixed by welding. Since the core clamps are made of the metal materials, insulating components such as small post insulators are required to be connected outside the core clamps to insulate high-voltage and low-voltage wiring from the metal channel steel. In this case, an insulating pad should also be provided outside the core, which, on one hand, insulates the core from the core clamps, and on the other hand, prevents eddy currents generated on the core clamps, thereby avoiding electromagnetic losses of the core caused by the eddy currents.

The core clamps 140 according to the embodiment of the present disclosure are made of fiber-reinforced composite materials. Compared with the core clamps with conventional channel steel structures, the core clamps 140 have better economic performance. On one hand, the insulating pad fixed to an outer surface of the core 110 is eliminated. On the other hand, the cost of the fiber-reinforced composite materials is lower than that of the metal materials, and an overall cost can be reduced by about 60%. Further, since the conventional channel steel structures are made of conductive metal materials, additional insulating components, such as small post insulators, are required to be connected to the core clamps for insulation. In this way, the costs are increased on one hand, and a weight of the entire device is increased on the other hand, which leads to much noise during the operation of the device. Further, high carbon emissions and serious pollution during the manufacturing of iron products. The core clamps 140 made of the fiber-reinforced composite materials address these issues. Further, the core clamps 140 made of the fiber-reinforced composite materials may not generate eddy current losses in composites, reducing no-load losses of the dry-type transformer 10. Based on the above, the core clamps 140 made of the fiber-reinforced composite materials have low costs, light weight, and good mechanical properties, and carbon emissions are low in the manufacturing process of the fiber-reinforced composite materials, which is greener and more environmentally friendly.

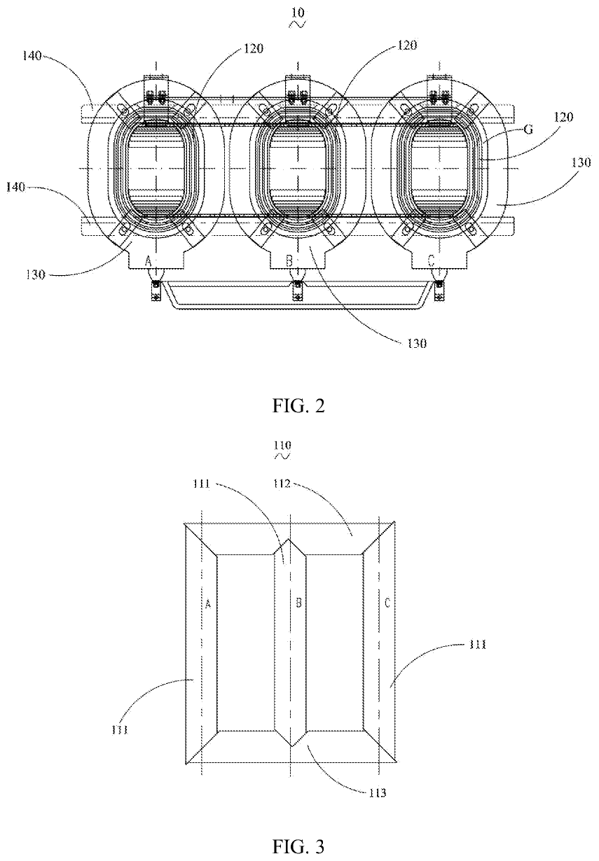

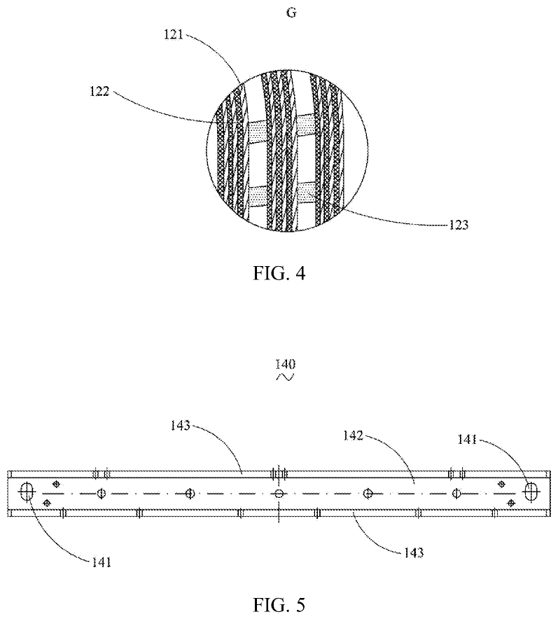

Referring to FIGS. 2 and 4, the low-voltage winding 120 includes a copper foil 121, a low-voltage insulating layer 122, and a support bar 123, and the copper foil 121 and the low-voltage insulating layer 122 are alternately arranged. The copper foil 121 is formed by winding an entire sheet of copper foil paper, and the low-voltage insulating layer 122 and the copper foil 121 are overlapped, and then wound together. In this way, an alternate arrangement of the copper foil 121 and the low-voltage insulating layer 122 is realized. At least one heat dissipation air duct is arranged in the low-voltage winding 120, and the heat dissipation air duct is located between the copper foil 121 and the low-voltage insulating layer 122 that are adjacent. The support bar 123 is located in the heat dissipation air duct to support and isolate the copper foil 121 and the low-voltage insulating layer 122 that are adjacent. Specifically, when the copper foil 121 and the low-voltage insulating layer 122 are overlapped and wound to a predetermined thickness, the support bar 123 is fixed to an outer surface of the low-voltage insulating layer 122 or the copper foil 121, and then overlapping and winding are continued to cause the copper foil 121 or the low-voltage insulating layer 122 to closely fit the support bar 123. Alternatively, the support bar 123 may be fixed, by gluing, between the copper foil 121 and the low-voltage insulating layer 122 that are adjacent, or fixed by extrusion force generated during the winding, or in other manners. The support bars 123 are arranged in the heat dissipation air duct in each layer. The support bars 123 are spaced apart along a circumferential direction of an outer peripheral surface of the copper foil 121, so as to support the copper foil 121 and the low-voltage insulating layer 122 that are adjacent. At least two support bars 123 are arranged in the heat dissipation air duct in each layer. Alternatively, two, three, four, or more support bars 123 may be provided. Preferably, Support bars 123 of the same layer are arranged at equal intervals along a circumferential direction of the outer peripheral surface of the copper foil 121. After the arrangement of the support bar 123, the copper foils 121 and the low-voltage insulating layers 122 are continuously overlapped and wound to a predetermined thickness to form the low-voltage windings 120. The heat dissipation air duct is intended to help release heat generated by the low-voltage winding 120 during the operation of the dry-type transformer 10, so as to prevent overheating failure of the dry-type transformer 10 due to heat accumulation. Alternatively, the heat dissipation air duct may be provided with one layer, or two or more layers, which is not limited herein.

The low-voltage insulating layers 122 are made of polyimide impregnated paper. Specifically, the low-voltage insulating layers 122 are made of SHS-P diphenyl ether prepreg material, which is formed by impregnating a polyimide film and a polysulfone fiber nonwoven soft composite material with diphenyl ether resin and baking. Alternatively, the low-voltage insulating layer may also use DMD insulating paper or a silicon rubber film, or other insulating materials, which may be selected according to different temperature rise levels of the dry-type transformer.

Alternatively, the support bar is an insulating support bar, which is made of glass fibers impregnated with epoxy resin or aramid fibers impregnated with epoxy resin. Alternatively, the support bar is a long strip with I-shaped cross-section, and has stable mechanical strength. Alternatively, the support bar may also be a long strip with square cross-section or cross-sections in other shapes, provided that the support bar can play roles of support and isolation. Alternatively, the support bar may also be made of a material such as aluminum tube.

An inner ring layer of the low-voltage winding 120 is further provided with an inner lead copper bar, and an outer ring layer of the low-voltage winding 120 is further provided with an outer lead copper bar. Free ends of the inner lead copper bar and the outer lead copper bar are provided with connecting holes. The connecting holes and the second through holes on the core clamps 140 are correspondingly matched, and then are fastened and connected with each other.

In another embodiment, referring to FIGS. 7 to 9 together, a core clamp of the dry-type transformer 20 includes two upper clamps 240 and two lower clamps 250. The upper clamps 240 have a same structure as the foregoing core clamps 140 and are made of fiber-reinforced composite materials. Details are not described again. The two lower clamps 250 are connected to and mounted on two sides of a core 210 through a plurality of screws and bolts used in conjunction with each other by connection. Specifically, the two lower clamps 250 are connected to and mounted on two sides of a lower yoke 213. Bottoms of the lower clamps 250 are connected to anchors 202 by bolts, forming a frame structure. Then, a low-voltage winding and a high-voltage winding are sleeved on the core 210 from top to bottom, the bottoms of the low-voltage winding and the high-voltage winding are both directly located on the lower clamps 250, and other components are finally mounted.

In this embodiment, different from the upper clamp 240, the lower clamp 250 is designed as a rectangular hollow pipe. That is, the lower clamp 250 has a closed structure formed by interconnecting and enclosing four clamps with plate structures. The lower clamp 250 is required to bear gravity loads of components such as the low-voltage winding, the high-voltage winding, and the like. The structure allows the lower clamp 250 to bear higher mechanical strength and have a more stable structure.

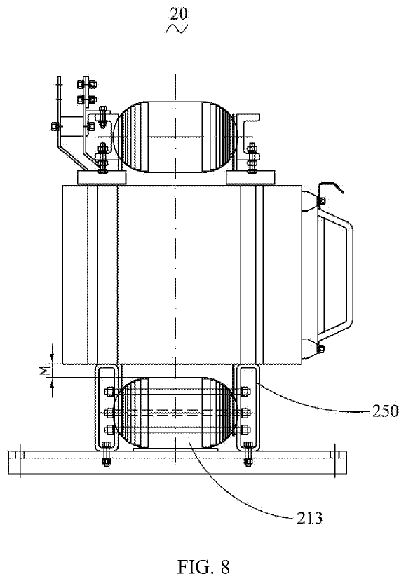

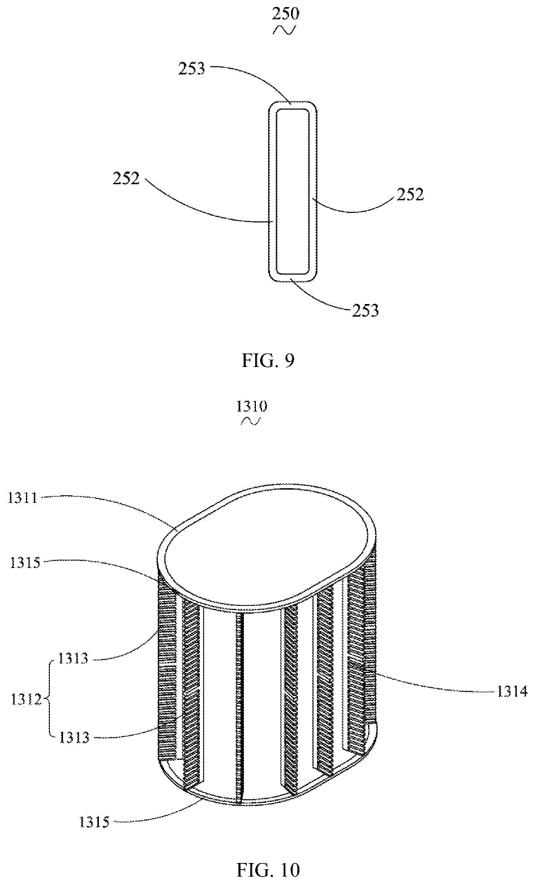

Referring to FIGS. 8 and 9 together, the four clamps of the lower clamp 250 include: two first clamps 252 and two second clamps 253. The two first clamps 252 are arranged along the vertical direction. The two second clamps 253 are arranged along the horizontal direction. The two first clamps 252 and the two second clamps 253 are interconnected and enclosed to form a closed rectangular structure. One of the first clamps 252 is arranged to be in close connection with the lower yoke 213. One of the second clamps 253 is arranged to be in close connection with the low-voltage winding and the high-voltage winding, and the other of the second clamps 253 is connected to the anchor 202 by a bolt. Alternatively, heights of the first clamps 252 along an axial direction of the core 210 are set to greater values, so that the bottoms of the low-voltage winding and the high-voltage winding are directly located on the second clamps 253, and gaps M are formed between the lower yoke 213 and the low-voltage winding and between the lower yoke 213 and the high-voltage winding. The gaps M can keep a safe electrical distance between a lower end of the low-voltage winding and the lower yoke 213 and between a lower end of the high-voltage winding and the lower yoke 213 respectively, which can prevent the arrangement of insulating pads between the lower clamps 250 and the low-voltage winding and between the lower clamps 250 and the high-voltage winding, saving costs.

The lower clamps 250 are made of fiber-reinforced composite materials, specifically glass fibers impregnated with epoxy resin. The lower clamps 250 made of the glass fibers impregnated with epoxy resin are light in weight and have good insulation properties and high mechanical strength, so that the low-voltage winding and the high-voltage winding can be directly placed on the lower clamps 250 without other supporting pad structures, thereby saving manufacturing costs and reducing a product weight. Further, since no supporting pad structure is required, On one hand, a step of adjusting positions and directions of supporting pads is omitted, which saves the time for product assembly and deployment, and improves product assembly efficiency; and on the other hand, overall structural stability of the dry-type transformer is strong, preventing risks of displacement of the low-voltage winding and the high-voltage winding and a change in the electrical distances caused by defects such as displacement of the supporting pads during product transportation.

As shown in FIGS. 10 to 15, the high-voltage winding 130 includes a winding body 1310, a high-voltage coil 1320, and a high-voltage insulating layer 1330. A wire is wound on the winding body 1310 to form the high-voltage coil 1320. The winding body 1310 includes a supporting barrel 1311 and a winding portion 1312. The supporting barrel 1311 is a hollow column, which may be a hollow cylinder, a hollow elliptical column, or other hollow columns. The winding portion 1312 is arranged on an outer peripheral surface of the supporting barrel 1311. The wire is wound in the winding portion 1312 to form the high-voltage coil 1320. The high-voltage coil 1320 includes a plurality of coil sections. The coil sections are spaced apart along an axial direction of the supporting barrel 1311. An axial direction of the winding body 1310 and an axial direction of the high-voltage winding 130 are same directions.

The winding portion 1312 includes a plurality of winding plates 1313. The winding plates 1313 are arranged at equal intervals on the outer peripheral surface of the supporting barrel 1311 in a circumferential direction of the supporting barrel 1311. Each winding plate 1313 extends along the axial direction of the supporting barrel 1311. An extension length of the winding plate 1313 along the axial direction of the supporting barrel 1311 is less than that of the supporting barrel 1311 along the axial direction thereof. At least two winding plates 1313 are provided. Alternatively, two, three, four, or more winding plates 1313 may be provided, which is not limited herein. Preferably, the number of winding plates 1313 of a dry-type transformer (such as a 10 kV/1000 kVA dry-type transformer) is set to twelve, so as to ensure reliable winding of a wire and save materials as much as possible. In other embodiments, the extension length of the winding plate along the axial direction of the supporting barrel may also be equal to that of the supporting barrel along the axial direction thereof.

The winding plate 1313 is a rectangular plate, and a longer side of the winding plate 1313 is arranged along the axial direction of the supporting barrel 1311. That is, a length direction of the winding plate 1313 is arranged along the axial direction of the supporting barrel 1311. The winding plate 1313 is further provided with a plurality of winding grooves 1314. The winding grooves 1314 extend along a radial direction of the supporting barrel 1311 and are distributed at intervals along the axial direction of the supporting barrel 1311, so that the winding plate 1313 is comb-shaped. That is, a plurality of comb teeth is formed on the winding plate 1313. Heights of the comb teeth on the winding plate 1313 along the axial direction of the supporting barrel 1311 are defined as tooth heights. Preferably, tooth heights of the comb teeth at two ends of the winding plate 1313 and tooth heights of the comb teeth in the middle of the winding plate 1313 are both greater than tooth heights of the comb teeth in other parts. This is due to uneven field strength at the ends of the high-voltage coil 1320, and a uniform electric field can be achieved by setting greater tooth heights at the two ends of the winding plate 1313. Moreover, taps of a tap wire are required to be led out from the middle of the winding plate 1313. If the tooth heights in the middle of the winding plate 1313 are set to greater values, a distance between corresponding two adjacent winding grooves 1314 is also greater, which may leave placement space for the taps led out from the middle of the winding plate 1313. A comb-tooth region with a greater tooth height is defined as a high comb-tooth region, while a comb-tooth region with a less tooth height is defined as a low comb-tooth region. Through the above configuration, a first high comb-tooth region, a first low comb-tooth region, a second high comb-tooth region, a second low comb-tooth region, and a third high comb-tooth region are sequentially formed on the winding plate 1313 from an end of the winding plate 1313 to the other end of the winding plate 1313 in the length direction of the winding barrel 1311. Further, specific tooth heights of the first high comb-tooth region, the second high comb-tooth region, and the third high comb-tooth region are not limited, which may be the same as or different from one another. Alternatively, the first high comb-tooth region and the third high comb-tooth region may be arranged symmetrically with respect to the second high comb-tooth region, and the first low comb-tooth region and the second low comb-tooth region may also be arranged symmetrically with respect to the second high comb-tooth region, so that the high-voltage coils 1320 are arranged symmetrically in the axial direction of the high-voltage winding 130. In this case, a center of gravity of the high-voltage winding 130 is located at a central position of the high-voltage winding 130, facilitating hoisting and transportation of the high-voltage winding 130. Alternatively, the first high comb-tooth region, the first low comb-tooth region, the second high comb-tooth region, the second low comb-tooth region, and the third high comb-tooth region may also be arranged asymmetrically, which is not limited herein. Alternatively, tooth heights of the comb teeth in each region may also be configured in an equal height or in other manners, which is not limited herein.

At least one coil section is arranged between two adjacent comb teeth on the winding plate 1313, so that a wire is wound in each winding groove 1314, the high-voltage coils 1320 are reasonably distributed and arranged, and the coil sections are spaced apart.

When the winding plates 1313 are arranged at equal intervals on the outer peripheral surface of the supporting barrel 1311 in the circumferential direction of the supporting barrel 1311, two ends of each winding plate 1313 are flush with each other, and the winding grooves 1314 on each winding plate 1313 match in a one-to-one correspondence manner in the circumferential direction of the supporting barrel 1311. For each coil section, the wire is wound in an annular winding groove formed by corresponding winding grooves 1314 on all the winding plates 1313 along the circumferential direction of the supporting barrel 1311, with balanced force and good mechanical strength.

In other embodiments, in order to avoid setting positions of the taps, the winding plates may also be fixed to the outer peripheral surface of the supporting barrel at unequal intervals. That is, a distance between two adjacent winding plates varies. For example, a distance between two adjacent winding plates is greater than that between any other two adjacent winding plates. In this case, each tap may be led out between two adjacent winding plates with a greater distance. In this way, the setting position of each tap can also be reserved without setting greater tooth heights of the comb teeth in the middle of the winding plates.

In other embodiments, the winding plates may also be annular disc members arranged circumferentially around the supporting barrel. The winding plates are spaced apart along the axial direction of the supporting barrel, and the wire is wound in recesses formed by two adjacent winding plates.

Alternatively, the supporting barrel 1311 is a hollow tube formed by winding and curing or pultrusion of glass fibers impregnated with epoxy resin, or a hollow tube formed by pultrusion and winding of glass fibers or aramid fibers impregnated with epoxy resin, or a hollow tube formed by winding and curing or pultrusion of aramid fibers impregnated with epoxy resin, or is made of other composite materials, which is not limited herein.

In an embodiment according to the present disclosure, the supporting barrel 1311 and the winding plate 1313 are two members separately formed and are bonded and fixed. The winding plate 1313 is also made of glass fibers impregnated with epoxy resin. Multi-layer glass fiber cloth is impregnated with epoxy resin and then superimposed to a certain thickness, and molded and cured to form a rectangular glass steel sheet. The glass steel sheet is provided with the winding grooves 1314. Specifically, the winding grooves 1314 may be formed by turning, so as to form the winding plates 1313. The winding plates 1313 are fixedly connected to the outer peripheral surface of the supporting barrel 1311 by an adhesive, thereby saving manufacturing materials and costs to the greatest extent. Alternatively, the adhesive is a two-component high-temperature resistant epoxy adhesive, or the adhesive may also be other adhesives, provided that the supporting barrel 1311 can be firmly bonded with the winding plates 1313 and the adhesive is high-temperature resistant, so as to adapt to high-temperature injection of the high-voltage insulating layer 1330 outside the winding body 1310.

In this embodiment, the winding plate 1313 is molded and cured. In other embodiments, the winding plate 1313 may also be integrally cast and cured to directly form a comb-shaped winding plate, which simplifies the process, and materials of the winding plate are the same as those described above. Details are not described again.

In another embodiment according to the present disclosure, the supporting barrel 1311 and the winding plates 1313 are integrally formed. A hollow tube with a large thickness is formed by pultrusion or winding of glass fibers or aramid fibers impregnated with epoxy resin, and then the hollow tube is turned to form the supporting barrel 1311 and the winding plate 1313. In this way, the materials are wasted, but strength between the supporting barrel 1311 and the winding plate 1313 can be ensured, and damages to the connection between the supporting barrel 1311 and the winding plate 1313 due to insecure bonding or subsequent injection of the high-voltage insulating layer 1330 are prevented.

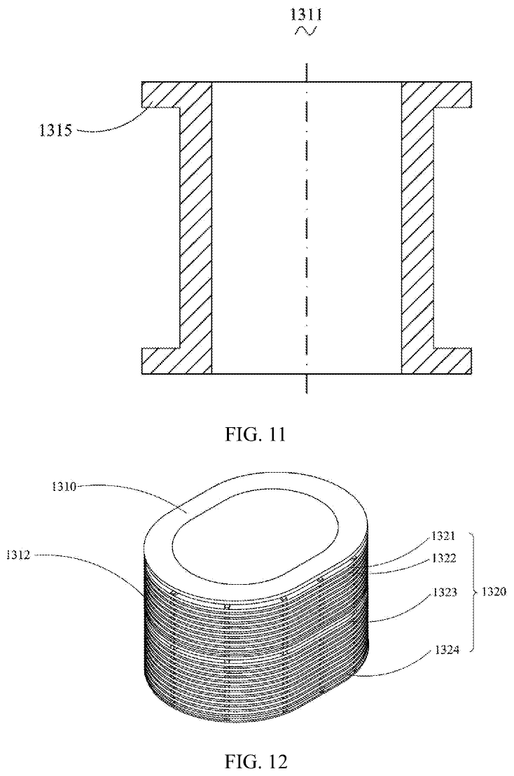

In yet another embodiment according to the present disclosure, referring to FIGS. 10 and 11 together, the winding body 1310 further includes two flanges 1315. The two flanges 1315 are arranged on two end portions of the supporting barrel 1311 respectively, and extend outward along the radial direction of the supporting barrel 1311 to form annular disc faces. The flanges 1315 at the two ends are arranged opposite to each other. When the winding plate 1313 is placed on the outer peripheral surface of the winding body 1310, outer end faces of two end portions of the winding plates 1313 abut against the disc faces of the two flanges 1315 opposite to each other, so as to prevent damages to the winding plates 1313 due to large injection pressure during the injection of the high-voltage insulating layer 1330. Alternatively, the outer end faces of the two end portions of the winding plate 1313 may not abut against the disc faces of the two flanges 1315 opposite to each other. That is, gaps are formed between the outer end faces of the two end portions of the winding plate 1313 and the disc faces of the two flanges 1315 facing the winding plate 1313, which is not limited herein. The flanges 1315 are made of glass fibers impregnated with epoxy resin and are integrally formed with the supporting barrel 1311. That is, the flanges are disc members with certain thicknesses, which is formed by pultrusion or winding, machining and polishing of glass fibers or aramid fibers impregnated with epoxy resin.

The winding body 1310 is made of the above fiber-reinforced composite material, which has characteristics of a light weight and high strength, so that the winding body 1310 has good mechanical strength, can effectively support the winding of the wire, is not prone to damages, and prevents scattering and displacement of the wire by injection impact force generated when high-temperature vulcanized silicone rubber is injected outside the winding body 1310. Moreover, the fiber-reinforced composite material has good heat resistance, preventing deformation of the winding body 1310 due to excessive heat generated by the high-voltage coil 1320 during the operation of the dry-type transformer 10.

Referring to FIGS. 10, 12, and 13 together, an A-phase transformer 100 is taken as an example. In an embodiment according to the present disclosure, the wire is wound circumferentially on the outer peripheral surface of the winding body 1310 to form the high-voltage coil 1320. Specifically, the wire is wound in the winding grooves 1314 of the winding portion 1312, so that the high-voltage coil 1320 is spaced apart along the axial direction of the supporting barrel 1311, and after the winding is completed, head and tail ends of the wire form two external terminals, namely, a first external terminal D and a second external terminal X. The first external terminal D is configured to connect a cable, and the second external terminal X is configured to connect other external wires, for example, the second external terminal X is configured to interconnect transformers in various phases in the three-phase transformer. Six taps are led out from the wire on the middle of the winding body 1310 along the axial direction thereof, which are a tap 2, a tap 3, a tap 4, a tap 5, a tap 6, and a tap 7 respectively. The six taps form a tap changer. For ease of description, the tap 2, the tap 4, and the tap 6 are defined as a first tap changer, and the tap 3, the tap 5, and the tap 7 are defined as a second tap changer.

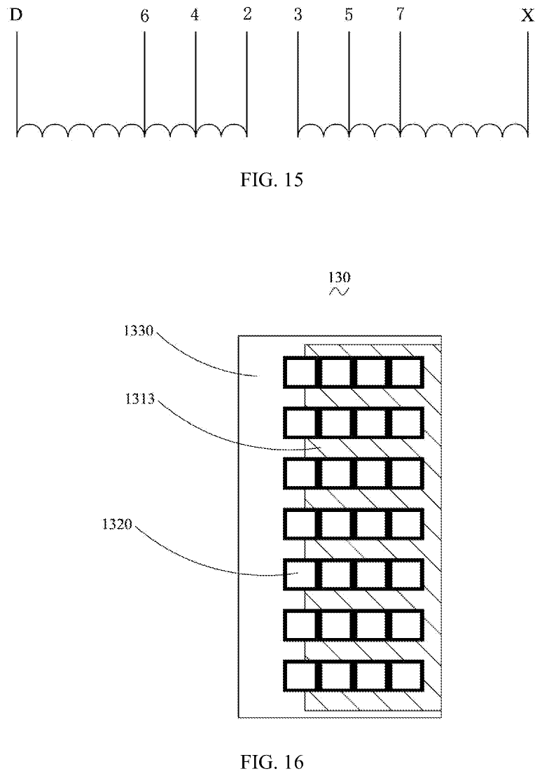

In an embodiment according to the present disclosure, referring to FIGS. 10, 12, and 15 together, the wire includes a first wire and a second wire. Both the first wire and the second wire are continuous wires, and both the first wire and the second wire are coated with an insulating layer. The insulating layer may be a polyimide film or a glass fiber film, or the insulating layer may be made of other insulating materials such as polyester paint, or made of a combination of a plurality of insulating materials, which is not limited herein. The first wire is wound from an end of the winding portion 1312 along the axial direction of the supporting barrel 1311 to the middle of the winding portion 1312, and three taps are led out from the first wire. Referring to FIG. 12, for ease of expression, an upper end of the winding portion 1312 is defined as a first end, and a lower end of the winding portion 1312 is defined as a second end. The first wire is wound from the first end of the winding portion 1312 to the second end of the winding portion 1312. The first wire is wound around an annular winding groove circle formed by the first winding grooves 1314 on all the winding plates 1313 with a designed number of turns to form a first coil section 1321. The first coil section 1321 is a disc coil. Only one disc coil is arranged in each winding groove 1314. That is, each coil section includes only one disc coil. An end of an inner-turn wire of the first wire located at the first end of the winding portion 1312 forms the first external terminal D exposed to the outside of the high-voltage insulating layer 1330. That is, the first external terminal D is led out from the end of the inner-turn wire of the first coil section 1321 (i.e., the first end of the first wire). An end of an outer-turn wire of the first coil section 1321 extends into an annular winding groove formed by the second winding grooves 1314 on all the winding plates 1313 and continues to be wound to form a second coil section 1322, and so on, until the first wire is wound to the middle of the winding body 1310, and three taps, i.e., the tap 6, the tap 4, and the tap 2 shown in FIG. 15, are respectively led out through outer-turn wire ends of the three coil sections. So far, the winding of the first wire is completed.

The second wire is wound from the middle of the winding portion 1312 along the axial direction of the supporting barrel 1311 to the second end of the winding portion 1312, and three other taps are led out form the second wire. Specifically, the second wire starts to be wound in an annular winding groove formed by next winding groove 1314 adjacent to the tap 2 to form a third coil section 1323. The second wire is continuously wound to the second end of the winding portion 1312 in a same manner as the first wire. Three other taps, i.e., the tap 3, the tap 5, and the tap 7, are respectively led out from three coil sections starting from the third coil section 1323, until the second wire is wound to an annular winding groove formed by the final winding groove 1314 on each winding plate 1313 at the second end of the winding portion 1312, so as to form the final coil section 1324. An end of an outer-turn wire of the second wire located at the second end of the winding portion 1312 forms a second external terminal X exposed to the outside of the high-voltage insulating layer 1330. That is, the second external terminal X is led out from the end of the outer-turn wire of the terminal coil section 1324 (i.e., a tail end of the second wire). So far, the winding of the second wire has been completed.

During the winding, the wire is wound in annular winding grooves formed by the winding grooves 1314 on all the winding plates 1313, so that each coil section formed by the winding of the wire is perpendicular to the axial direction of the supporting barrel 1311, it is convenient for the winding, and the wire is arranged orderly. The winding plates 1313 and the supporting barrel 1311 are evenly stressed and have good mechanical strength.

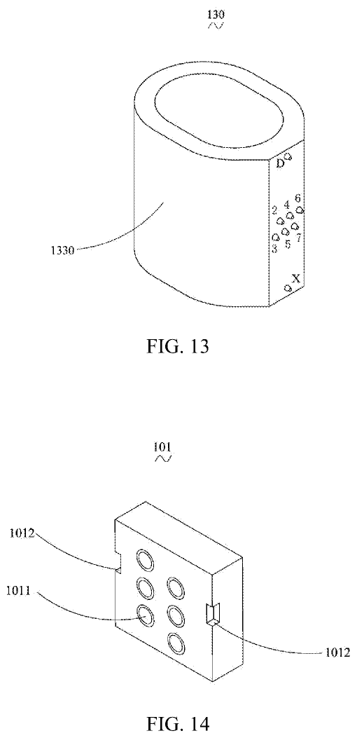

In this way, a disc high-voltage coil 1320 is formed. The coil structure has good mechanical strength, and has strong bearing capability for electric power generated by a short-circuit current, which has more discs and better heat dissipation capability than a layer coil. Moreover, in the axial direction of the supporting barrel 1311, referring to FIGS. 13 and 15 together, the tap 6, the tap 4, and the tap 2 are sequentially distributed to form a first tap changer, the tap 3, the tap 5, and the tap 7 are sequentially distributed to form a second tap changer, and the first tap changer and the second tap changer are arranged in parallel. The six taps form a tapping apparatus of the high-voltage coil 1320, which is configured to regulate a voltage by the dry-type transformer 10 according to different operating conditions.

The wire is wound on the winding body 1310 to form the high-voltage coil 1320. Therefore, the high-voltage coil 1320 is ring-shaped. If a ring width of the high-voltage coil 1320 is defined as a width of the high-voltage coil 1320, widths of the high-voltage coil 1320 in various radial sections are identical. That is, an outer side face of the high-voltage coil 1320 is equidistant from the outer peripheral surface of the supporting barrel 1311, so that the overall force of the high-voltage coil 1320 is balanced. Alternatively, in consideration of an actual operation, the widths of each coil on the radial sections thereof may not be exactly the same, provided that the widths are roughly the same.

In this embodiment, the second wire starts to be wound from an annular winding groove formed by next winding grooves 1314 adjacent to the tap 2 to a winding annular groove formed by the final winding grooves 1314 at the second end of the winding portion 1312. In other embodiments, the second wire may also start to be upwards wound from the annular winding groove formed by the final winding grooves 1314 at the second end of the winding portion to the annular winding groove formed by next winding grooves 1314 adjacent to the tap 2, but only the second external terminal X is formed first, and then the tap 7, the tap 5, and the tap 3 are sequentially formed. Certainly, the manner of winding the high-voltage coil 1320 is not limited to the above manners, and a disc coil or layer coil may also be formed in other manners, provided that the high-voltage winding 130 can be finally formed.

In this embodiment, the tap changer includes six taps. In this case, the dry-type transformer 10 has five gears for regulating the voltage. In other embodiments, the tap changer may include four taps. That is, the first tap changer and the second tap changer include two taps respectively. In this case, the dry-type transformer includes three gears for regulating the voltage, provided that the voltage is in line with an actual use requirement of the dry-type transformer, which is not limited herein.

As shown in FIGS. 12 to 14, the high-voltage winding 130 is formed by wrapping the high-voltage coil 1320 and the winding body 1310 through the high-voltage insulating layer 1330. The high-voltage insulating layer 1330 is made of injection-molded silicone rubber, such as high-temperature vulcanized silicone rubber or liquid silicone rubber for injection. The injection-molded silicone rubber is molded by an injection process, which has a fast molding-speed, high production efficiency, no cracks and air gaps, and small partial discharge of the dry-type transformer 10. Moreover, since it is a silicone rubber elastomer, after assembly, elastic vibration reduction can be realized at parts where the high-voltage winding 130 is connected to various components, which greatly reduces noise during the operation of the dry-type transformer 10. In an example that the high-voltage insulating layer 1330 is made of high-temperature vulcanized silicone rubber, firstly, the wire is wound on the winding body 1310 to form the high-voltage coil 1320, the winding body 1310 and the high-voltage coil 1320 are used as a to-be-injected body, and the to-be-injected body is put into a mold of an injection molding machine; and by adding silicone rubber raw materials, the high-temperature vulcanized silicone rubber is integrally injected around a periphery of the to-be-injected body to obtain the high-voltage winding 130. The high-voltage insulating layer 1330 is made of the high-temperature vulcanized silicone rubber, which improves insulation and mechanical properties of the high-voltage winding 130.

The high-temperature vulcanized silicone rubber according to the embodiment of the present disclosure is a high-temperature vulcanized silicone rubber material system, specifically including raw rubber, reinforcing agent, flame retardant, heat resistant agent, and other auxiliary materials.

After the high-temperature vulcanized silicone rubber is wrapped around the high-voltage coil 1320 and the winding body 1310 by integral vacuum injection, the high-temperature vulcanized silicone rubber fills the gaps between the high-voltage coil 1320 and the winding body 1310 and is wrapped around the two ends of the winding body 1310, and the high-temperature vulcanized silicone rubber is not wrapped around an inner wall of the supporting barrel 1311, so that the high-voltage winding 130 is in the shape of a hollow column as a whole. Alternatively, the high-voltage winding 130 may be a hollow cylinder, a hollow elliptical column, or other hollow columns.

Prior to the integral injection of the high-temperature vulcanized silicone rubber, the six taps are connected by arranging a tooling connector 101 to avoid that the six taps are also wrapped with the silicone rubber during the injection and cannot be used for wiring. As shown in FIG. 14, the tooling connector 101 is an aluminum alloy sheet. A plate surface of the tooling connector 101 is provided with a protective chamber. The taps are connected and fixed to the protective chamber. In the present disclosure, the protective chamber includes six identical stepped holes 1011, and inner walls of the stepped holes 1011 are also provided with threads. The six taps are respectively connected to the six stepped holes 1011. The taps and the stepped holes may be connected by welding or fixedly connected in other manners, which is not limited herein. Moreover, the six stepped holes 1011 in the tooling connector 101 are arranged in two rows in parallel, and each row is provided with three stepped holes 1011, so that the first tap changer and the second tap changer are also arranged in parallel. In this case, prior to the integral injection, after the six taps are respectively connected to the six stepped holes 1011, a bolt is connected in each of the six stepped holes 1011. In this way, the bolts can directly fill the remaining space of the stepped holes 1011, preventing filling of the six stepped holes 1011 with the silicone rubber, so as to avoid that the six taps are wrapped with the silicone rubber and cannot be used for wiring.

Two opposite side faces of the tooling connector 101 are further provided with two symmetrical connection grooves 1012. An injection mold is correspondingly provided with two connection blocks. When the tooling connector 101 is placed in the injection mold, the connection grooves 1012 on the tooling connector are clamped and connected to the two connection blocks on the injection mold respectively to fix the tooling connector 101 in the injection mold, so as to prevent shift of the position of the tooling connector 101 due to large injection pressure during the injection of the silicone rubber.

In other embodiments, alternatively, the two opposite side faces of the tooling connector may be provided with two symmetrical connection blocks, and the injection mold is correspondingly provided with two connection grooves. When the tooling connector is placed in the injection mold, the connection blocks on the tooling connector are clamped and connected to the connection grooves on the injection mold respectively to fix the tooling connector in the injection mold, so as to prevent shift of the position of the tooling connector due to large injection pressure during the injection of the silicone rubber. After the high-voltage insulating layer 1330 is formed by integral injection, a side face of the tooling connector 101 is wrapped with a small amount of silicone rubber. Since amount of silicone rubber wrapped on the tooling connector 101 is wrapped relatively small, the tooling connector 101 can be directly removed with a tool to expose the first tap changer and the second tap changer, so as to finally form the high-voltage winding 130 as shown in FIG. 13.

In this embodiment, one tooling connector 101 is provided. In other embodiments, two tooling connectors may also be provided. In this case, the tooling connectors are of a smaller size, each tooling connector is provided with three stepped holes, and the six taps are connected to the six stepped holes respectively, which is not limited herein.

In this embodiment, as shown in FIG. 16, FIG. 16 is a partial sectional view cut along an axial direction of the high-voltage winding 130 showing the high-voltage winding 130 wrapped with the high-voltage insulating layer 1330. The wire is wound in the comb-shaped winding plates 1313 with the foregoing winding method to form a disc high-voltage coil 1320. Along the axial direction of the high-voltage winding 130, the disc high-voltage coil 1320 and comb teeth of the winding plates 1313 are spaced part. That is, one disc coil is arranged between two adjacent comb teeth.

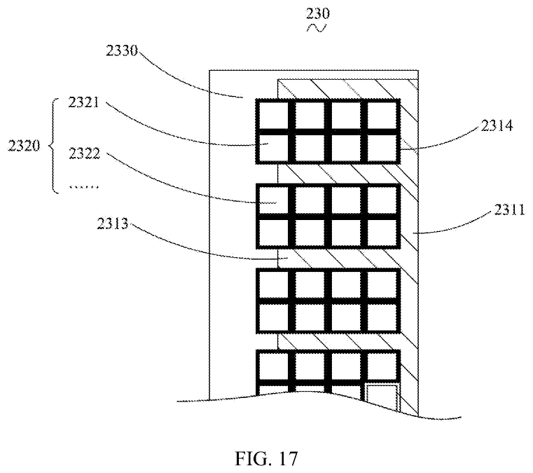

In another embodiment, as shown in FIG. 17, FIG. 17 is a partial sectional view cut along an axial direction of a high-voltage winding 230 showing a high-voltage winding 230 wrapped with a high-voltage insulating layer 2330. The wire is wound on a comb-shaped winding plate 2313 through a double-winding continuous winding method to form a high-voltage coil 2320. Two identical continuous wires are arranged adjacent to each other, and start to be wound simultaneously from an annular winding groove formed by the winding grooves 2314 corresponding to upper ends of all the winding plates 2313 to form a first coil section 2321. The first coil section 2321 includes two disc coils arranged next to each other along an axial direction of a supporting barrel 2311. The specific winding method is the same as that of the high-voltage coil 1320 in the previous embodiment, and the winding proceeds downward by analogy to continuously form other coils such as a second coil section 2322, until the high-voltage coils 2320 spaced apart along the axial direction of the high-voltage winding 230 is formed. Each coil section includes two disc coils arranged next to each other. A length of each coil section along the axial direction of the winding plate 2313 is equal to a sum of widths of two parallel wires along the axial direction of the supporting barrel 2311. That is, two disc coils are arranged between two adjacent comb teeth on the winding plate 2313. In the present disclosure, the two identical wires refer to two wires with identical sizes and materials. Compared with a continuous winding structure of a single wire (i.e., the structure of the foregoing high-voltage coil 1320), the number of winding grooves 2314 can be reduced in the high-voltage winding with the same size and specification, thereby reducing wire transition sections between interval segments of each coil section, reducing a usage amount of the wire, and achieving a purpose of reducing costs. In other embodiments, three disc coils or more disc coils may also be arranged between two adjacent comb teeth on the winding plate.

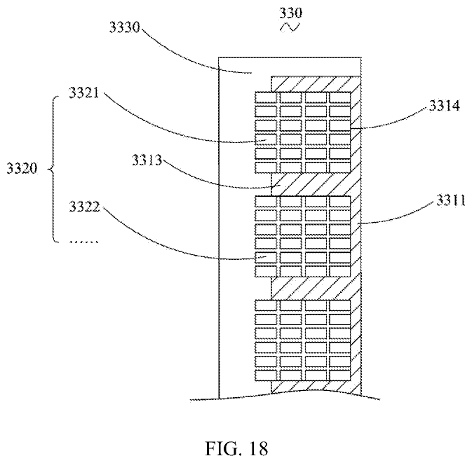

In yet another embodiment, as shown in FIG. 18, FIG. 18 is a partial sectional view cut along an axial direction of a high-voltage winding 330 showing the high-voltage winding 330 wrapped with a high-voltage insulating layer 3330. Widths of winding grooves 3314 on winding plate 3313 along an axial direction of a supporting barrel 3311 are greater than widths of the winding grooves 2314 on the winding plate 2313 along the axial direction of the supporting barrel 2311. A wire is first wound in layers to form a first coil section 3321. Specifically, in an annular winding groove formed by first winding grooves 3314 on upper ends of all the winding plates 3313, a continuous wire is continuously wound downward at an upper end in the annular winding groove formed by first winding grooves 3314 along the axial direction of the supporting barrel 3311 until the wire is wound to a lower end of the annular winding groove formed by the first winding grooves 3314, so as to form a first coil layer. The wire of the first coil layer is tightly arranged in a spiral shape on an outer peripheral surface of the supporting barrel 3311. After the first coil layer is formed by winding, the wire is continuously wound reversely upward from a lower end of the annular winding groove formed by the first winding grooves 3314 along the axial direction of the supporting barrel 3311, so as to form a second coil layer, the winding reciprocates by analogy until the first coil section 3321 reaches a preset width of the high-voltage coil 3320 in a radial direction of the supporting barrel 3311, and finally the first coil section 3321 is tightly arranged in a spiral shape on an outer peripheral surface of the supporting barrel 3311. Then, the wire transits to an annular winding groove formed by the second winding grooves 3314 through the comb teeth of the winding plates 3313, and continues to be wound in layers to form a second coil section 3322, and the winding is continued by analogy until the winding of the wires in all the winding grooves 3314 is completed, so as to finally form the high-voltage coil 3320.

Since a width of the winding groove 3314 along the axial direction of the supporting barrel 3311 is relatively large, each coil section is arranged in a spiral shape along the axial direction of the winding plate 3313, and a length of each coil section along the axial direction of the winding plate 3313 is greater than a sum of widths of two parallel wires, so as to form a multi-section cylindrical high-voltage coil 3320. Compared with the disc structure formed by winding with the double-winding continuous winding method (i.e., the structure of the high-voltage coil 2320 in the foregoing embodiment), the high-voltage coil 3320 is more compact and fewer winding grooves 3314 are provided in the high-voltage winding of the same specification, so that the usage amount of the wire is less, thereby further achieving the purpose of reducing the costs.

In this embodiment, through the arrangement of the winding plates 3313, the first coil section 3321 and the second coil section 3322 are separated by comb teeth. In other embodiments, the winding plates may not be provided, a gap is provided between the first coil section and the second coil section, and the high-voltage coil is finally fixed by filling with the high-voltage insulating layer, which can also achieve a purpose of insulating the high-voltage coil sections.

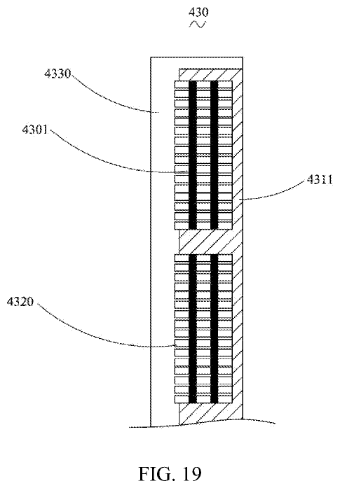

In another embodiment, as shown in FIG. 19, FIG. 19 is a partial sectional view cut along an axial direction of a high-voltage winding 430 showing the high-voltage winding 430 wrapped with a high-voltage insulating layer 4330. A high-voltage coil 4320 is formed in a same manner as the high-voltage coil 3320, which is not described in detail herein. However, a length of each coil section of the high-voltage coil 4320 along an axial direction of a supporting barrel 4311 is greater than a length of each coil section of the high-voltage coil 3320 along the axial direction of the supporting barrel 3311. For the dry-type transformer 10 with the same voltage rating, a segmented cylindrical high-voltage coil 4320 has fewer sections. Since the length of each coil section of the high-voltage coil 4320 along the axial direction of the supporting barrel 4311 is greater, a voltage difference between each coil section is greater. Therefore, insulating layers are required to be added between layers of each coil section to reduce the voltage difference. In this case, each coil section is provided with an interlayer insulating layer 4301 along the axial direction of the high-voltage winding 430 to prevent that strength of an interlayer electric field is higher than a withstand critical value of an insulation film of an insulation wire. Moreover, the layered structure in each coil section has strong lightning impulse resistance and more obvious economic advantages. Specifically, when the wire is wound in layers to a certain thickness, the interlayer insulating layer 4301 is placed at a corresponding position and then the wire is continuously wound, and the interlayer insulating layer 4301 may be arranged in each coil section.

The interlayer insulating layer 4301 may be made of mesh cloth, or insulation braces circumferentially spaced apart, or made of other hard insulating materials. Moreover, the insulation braces are long insulation strips with wavy edges, which can prevent damages to the insulation braces due to extremely high injection pressure when the high-temperature vulcanized silicone rubber is injected to form the high-voltage insulating layer. Besides, the insulation braces are made of hard insulating materials, which can resist the impact during high-temperature injection of the silicone rubber. One, two, or three interlayer insulating layers 4301 may be provided, depending on different designs, which is not limited herein.

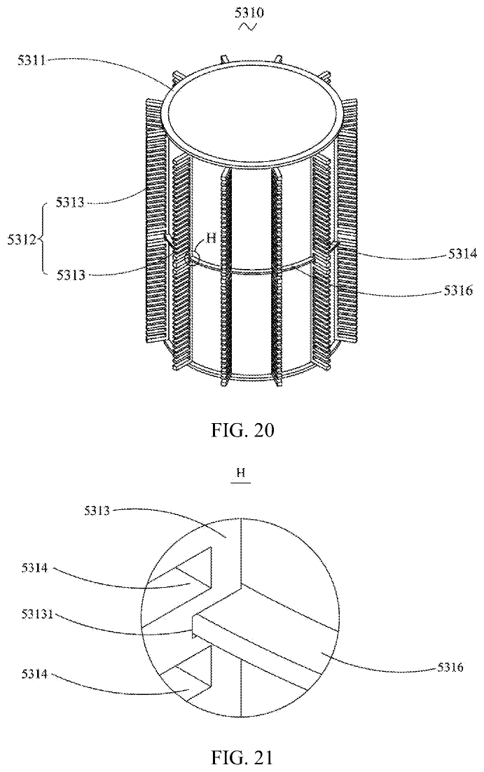

In an embodiment of the present disclosure, referring to FIGS. 20 to 21 together, a winding body 5310 is similar to the winding body 1310 in structure, but a difference is that a supporting barrel 5311 is clamped and connected to a winding portion 5312. Specifically, the winding body 5310 further includes an auxiliary member 5316. The auxiliary member 5316 is located at a middle position on an outer peripheral surface of the supporting barrel 5311 and extends outward along a radial direction of the supporting barrel 5311, so that the auxiliary member 5316 surround the supporting barrel 5311 to form an annular disc face. The winding plate 5313 or the auxiliary member 5316 is provided with a slot, and the winding plate 5313 and the auxiliary member 5316 are clamped and connected through the slot. In this embodiment, each winding plate 5313 is provided with a first slot 53131, and the position of the first slot 53131 matches the position of the auxiliary member 5316, so that the auxiliary member 5316 is clamped in the first slot 53131.

A longer side of the winding plate 5313 is arranged along the axial direction of the supporting barrel 5311. Winding grooves 5314 are arranged along the radial direction of the supporting barrel 5311 and are spaced apart along the axial direction of the supporting barrel 5311, so that a plurality of comb teeth is formed on the winding plate 5313. The first slot 53131 is located on the winding plate 5313 and faces away from the winding groove 5314. That is, the first slot 53131 is arranged along the radial direction of the supporting barrel 5311, and the first slot 53131 is located on a side face of the winding plate 5313 close to the supporting barrel 5311, so that the auxiliary member 5316 protruding from the outer peripheral surface of the supporting barrel 5311 can be clamped in the first slot 53131. The auxiliary member 5316 can maintain stable arrangement of the winding plate 5313, preventing displacement and dislocation of the winding plate 5313 during the winding of the wire and the injection of the high-voltage insulating layer.

The first slot 53131 is located in the middle of the winding plate 5313, and in the radial direction of the supporting barrel 5311, the first slot 53131 extends from a side of the winding plate 5313 close to the supporting barrel 5311 to a comb tooth in the middle of the winding plate 5313. Alternatively, in the radial direction of the supporting barrel 5311, the first slot 53131 is flush with the comb tooth in the middle of the winding plate 5313, but does not extend onto the comb tooth. On one hand, the influence on mechanical strength of the winding plate 5313 and even breakage of the winding plate 5313 due to the arrangement that the first slot 53131 is flush with the winding groove 5314 are prevented. On the other hand, a tooth height of the comb tooth in the middle of the winding plate 5313 is large, which can further reduce the influence of the first slot 53131 on the mechanical strength of the winding plate 5313. Further, a slot depth of the first slot 53131 in the radial direction of the supporting barrel 5311 matches a width of the auxiliary member 5316 protruding from the supporting barrel 5311, so that after the auxiliary member 5316 is assembled with the winding plate 5313, an outer side of the auxiliary member 5316 is closely attached to an inner side of the first slot 53131, with good mechanical strength and reliable fastening. If the slot depth of the first slot 53131 is less than the width of the auxiliary member 5316 protruding from the supporting barrel 5311, there is a gap between the winding plate 5313 and the supporting barrel 5311, which may cause a risk that the winding plate 5313 may bend around the auxiliary member 5316 during the winding of the wire and the injection of the high-voltage insulating layer. If the slot depth of the first slot 53131 is greater than the width of the auxiliary member 5316 protruding from the supporting barrel 5311, there is a gap between the first slot 53131 and the auxiliary member 5316, the auxiliary member 5316 cannot play a role of fastening.

The auxiliary member 5316 is made of glass fibers impregnated with epoxy resin. First, a disc member with a certain thickness is formed by molding, and then the auxiliary member 5316 is fixedly connected to the outer peripheral surface of the supporting barrel 5311 by an adhesive, so as to save materials and costs to the greatest extent. Alternatively, the auxiliary member may also be integrally formed with the supporting barrel, that is, a hollow tube with a large thickness is made first, and then the hollow tube is turned to form the winding plate 5313 and the auxiliary member 5316 at the same time.

In this embodiment, an auxiliary member 5316 and one group of first slots 53131 are provided. In other embodiments, a plurality of, such as two or three, auxiliary members may be provided. Correspondingly, a plurality of, such as two or three, groups of first slots may be spaced apart along the axial direction of the supporting barrel. In such embodiments, various groups of auxiliary members and first slots are spaced apart along the axial direction of the supporting barrel, which effectively evenly distributes bearing strength of the winding plate, making the structure of the winding plate more stable. For example, in an embodiment, the outer peripheral surface of the supporting barrel is provided with an auxiliary member at each of the middle position and the two ends, and each winding plate is correspondingly provided with three first slots.

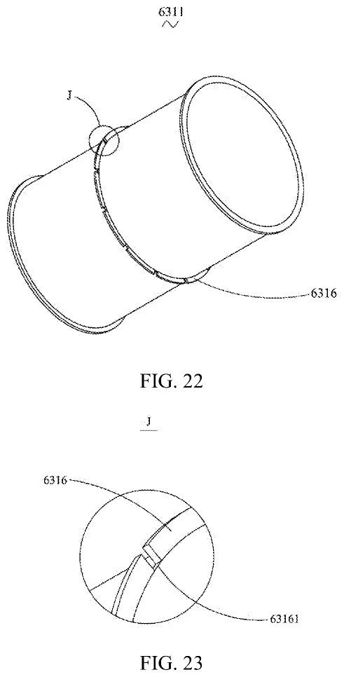

In an embodiment according to the present disclosure, referring to FIGS. 22 and 23 together, different from the supporting barrel 5311 in the foregoing embodiment, an auxiliary member 6316 on an outer peripheral surface of a supporting barrel 6311 is provided with a plurality of second slots 63161, and the second slots 63161 are evenly distributed in a circumferential direction of the auxiliary member 6316. That is, each second slot 63161 matches and corresponds to one winding plate. In such embodiments, there is no need to arrange any slot on the winding plate, and the winding plate may be directly clamped in the second slots 63161. On one hand, stable arrangement of the winding plate can be maintained, preventing displacement and dislocation of the winding plate during the winding of the wire and the injection process of the high-voltage insulating layer. On the other hand, the influence on the mechanical strength of the winding plate due to the arrangement of the slots on the winding plate can be prevented. The material and the forming method of the auxiliary member 6316 are the same as those of the foregoing auxiliary member 5316, which are not described in detail herein.

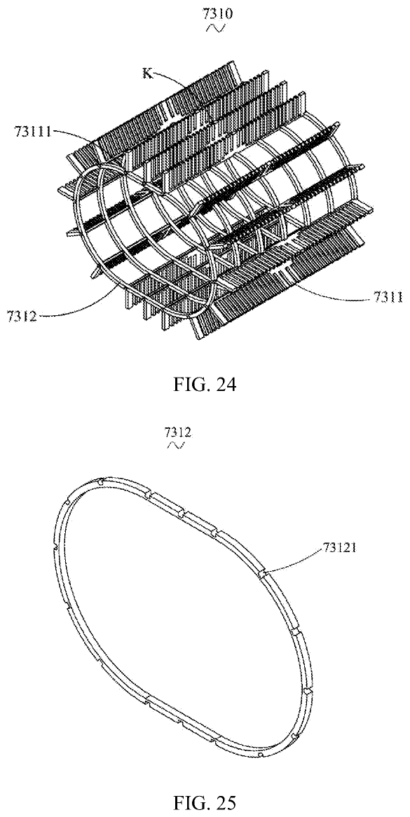

In other embodiments, as shown in FIGS. 24 and 25, the winding body may include only the winding portion 7310, namely, the winding body may not be provided with the supporting barrel. That is, a structure of a rigid insulating liner barrel is omitted in the winding body, which makes a heat conduction effect of the high-voltage winding better, and eliminates an interface between the high-voltage insulating layer and the rigid insulating liner barrel, thereby inhibiting surface discharge of the rigid insulating liner barrel, saving materials, and reducing costs.

Specifically, the winding portion 7310 includes a plurality of comb-shaped winding plates 7311 and a plurality of auxiliary members 7312. The auxiliary members 7312 are ring-shaped and spaced apart along axial directions of the auxiliary members 7312. The winding plates 7311 are fixed to peripheries of the plurality of auxiliary members 7312 along the axial directions of the auxiliary members 7312. Each winding plate 7311 is connected to all the auxiliary members 7312 at the same time. The winding plates 7311 are evenly distributed along circumferential directions of the auxiliary members 7312. The axial direction of the auxiliary member 7312 is an axial direction of the winding portion 7310, that is, an axial direction of the high-voltage winding. The auxiliary member 7312 may be in a shape of circular ring or elliptical ring, which may be designed according to an overall shape of the high-voltage winding. The winding plates 7311 are arranged along circumferential directions of the auxiliary member 7312, the wire is wound on the winding portion 7310 to form a high-voltage coil, and the high-voltage coil includes a plurality of coil sections. The coil sections are spaced along the axial direction of the high-voltage winding. The high-voltage insulating layer is wrapped around the high-voltage coil, the plurality of auxiliary members 7312, and the winding plates 7311. The auxiliary member 7312 can maintain stable arrangement of the winding plate 7311, preventing displacement and dislocation of the winding plate 7311 during the winding of the wire and the injection of the high-voltage insulating layer.

In an embodiment, an outer surface of the auxiliary member 7312 is provided with a plurality of third slots 73121. The third slots 73121 are evenly arranged along the circumferential direction of the auxiliary member 7312. The third slots 73121 of the plurality of auxiliary members 7312 are aligned with one another in the axial directions of the auxiliary members 7312 to form a plurality of third slot columns. The number of the third slot columns corresponds to that of the winding plates 7311. Each winding plate 7311 is clamped in one corresponding third slot column, causing the plurality of winding plates 7311 to be circumferentially evenly distributed on peripheries of the plurality of auxiliary members 7312. Further, two ends of all the winding plates 7311 are flush with each other, and the third slots 73121 on all the auxiliary members 7312 match in one-to-one correspondence in the axial directions of the auxiliary members 7312, which enables each winding plate 7311 to be arranged along the axial direction of the auxiliary member 7312, and then causes the wire to be wound in comb teeth on the winding plate 7311 to form a high-voltage coil. That is, the coil sections of the high-voltage coil are spaced apart in the axial direction of the winding portion 7310, with balanced force and good mechanical strength.

Widths of the third slot 73121 in the circumferential directions of the auxiliary member 7312 are defined as slot width of the third slot 73121. The slot width of the third slot 73121 match thicknesses of the winding plate 7311, so that the winding plate 7311 is firmly assembled with the auxiliary member 7312, preventing difficult alignment and fixation of the winding plate 7311 with and to the auxiliary member 7312 when the slot width of the third slot 73121 is less than the thickness of the winding plate 7311, or falling of the winding plate 7311 from the auxiliary member 7312 when the slot width of the third slots 73121 is greater than the thickness of the winding plate 7311. The winding plate 7311 is fixedly connected to the third slot 73121 by an adhesive. The adhesive is a two-component high-temperature resistant epoxy adhesive, which may also be other adhesives, but there is a need to ensured that the adhesive enables a firm bonding between the winding plate 7311 and the auxiliary member 7312. Besides, the adhesive is required to be high-temperature resistant, so as to adapt to the wrapping of the high-voltage insulating layer around the winding plate 7311 and the auxiliary member 7312 by high-temperature injection.

In other embodiments, the slot may also be arranged on side faces of the winding plate close to the auxiliary member, and the auxiliary member is clamped in the slot of the winding plate, so that the winding plate is fixedly connected to the auxiliary member. Preferably, as in the foregoing embodiment, the auxiliary member 7312 is provided with the third slot 73121, which prevents weakening of the mechanical strength of the winding plate due to the arrangement of the slot on the winding plate.

Still referring to FIG. 24, the winding plate 7311 is a comb-tooth plate 7311. The winding plate 7311 is similar to the foregoing winding plate 1313 in structure, and a difference is that each end of the winding plate 7311 is provided with a flow groove 73111, which allows injected silicone rubber raw materials to flow from an end portion of the winding portion 7310 into an inner side of the winding portion 7310 during injection molding of the high-voltage insulating layer, and then causes the high-voltage insulating layer to fully fill a gap between the winding portion 7310 and the high-voltage coil and to be wrapped around two ends of the winding portion 7310.

The winding plate 7311 and the auxiliary member 7312 are both made of glass fibers impregnated with epoxy resin. Several layers of glass fiber cloth impregnated with epoxy resin are superimposed to a certain thickness, and molded and cured to form glass steel. In this embodiment, the winding plate 7311 and the auxiliary member 7312 are separately formed and then bonded and fixed. In other embodiments, the winding plate and the auxiliary member may also be integrally formed.

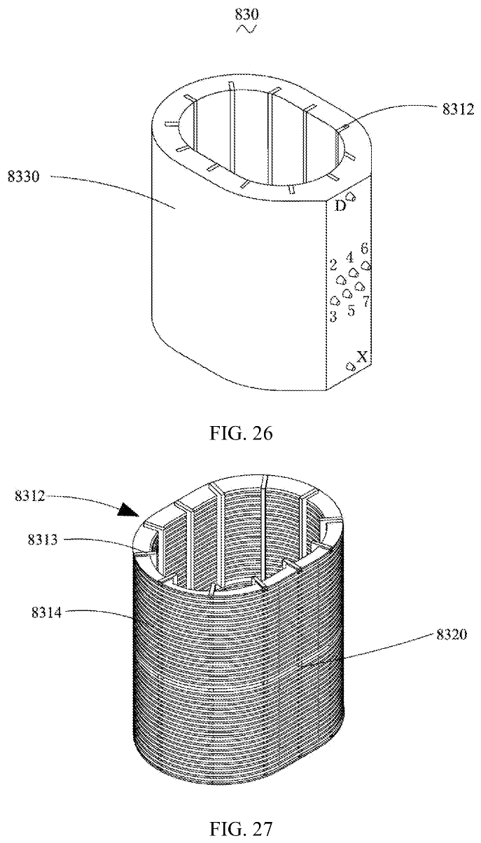

In another embodiment, referring to FIGS. 26 and 27, a high-voltage winding 830 includes a winding portion 8312, a high-voltage coil 8320, and a high-voltage insulating layer 8330. The winding portion 8312 is arranged circumferentially inside the high-voltage winding 830, and a wire is wound on an outer side of the winding portion 8312 to form the high-voltage coil 8320. The high-voltage insulating layer 8330 is wrapped around the high-voltage coil 8320 and the winding portion 8312. Compared with the high-voltage winding 130 in the foregoing embodiment, the high-voltage winding 830 is provided with only the winding portion 8312 as a winding body, but not provided with a rigid insulating liner barrel, that is, not provided with the supporting barrel. The structure of the rigid insulating liner barrel is omitted. On one hand, a heat conduction effect of the high-voltage winding 830 is better, and an interface between the high-voltage insulating layer 8330 and the rigid insulating liner barrel is eliminated, thereby inhibiting surface discharge of the rigid insulating liner barrel. On the other hand, materials are saved, and costs are reduced.

The winding portion 8312 includes a plurality of comb-shaped winding plates 8313. The winding plates 8313 are spaced apart and arranged at equal intervals in a circumferential direction of an inner side of the high-voltage winding 830. Each winding plate 8313 is arranged along an axial direction of the high-voltage winding 830. The high-voltage coil 8320 includes a plurality of coil sections. At least one section coil is arranged between two adjacent comb teeth on the winding plate 8313. At least two winding plates 8313 are provided. Alternatively, two, three, four, or more winding plates 8313 may be provided, which is not limited herein.

The winding plate 8313 is further provided with a plurality of winding grooves 8314, so that the winding plate 8313 is comb-shaped. That is, a plurality of comb teeth is formed on the winding plate 8313. The specific structure, material, and molding manner of the winding plate 8313 are the same as those of the foregoing winding plate 1313. Details are not described herein again.

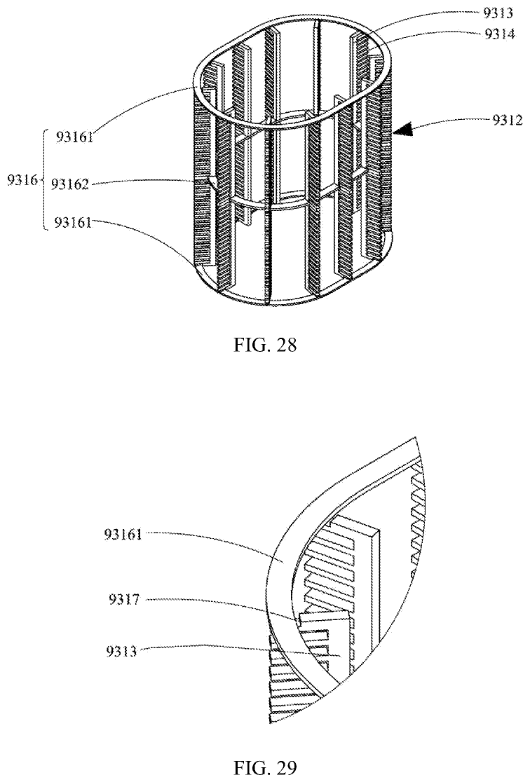

In another embodiment, as shown in FIGS. 28 to 31, a high-voltage winding 930 is basically the same as the foregoing high-voltage winding 830, but a difference lies in that the winding portion 9312 further includes an auxiliary member 9316, and the auxiliary member 9316 is ring-shaped and coaxial with the high-voltage winding 930, sleeves, and is fixed to the plurality of winding plates 9313. The arrangement of the auxiliary member 9316 can maintain stable arrangement of the winding plates 9313, preventing displacement and dislocation of the winding plates 9313 during the winding of the wire and the injection of the high-voltage insulating layer.

Specifically, the auxiliary member 9316 includes at least one end-portion auxiliary member 93161. The end-portion auxiliary member 93161 is arranged on outer sides of end portions of the winding plates 9313, which can maintain stable arrangement of the winding plates 9313 without affecting the winding of the wire. Referring to FIG. 29, the outer side of the end portion of the winding plate 9313 is provided with a recess 9317, and the end-portion auxiliary member 93161 is embedded into the recess 9317, ensuring an effective connection between the end-portion auxiliary member 93161 and the winding plate 9313. The recess 9317 is located on a comb-tooth side of the winding plate 9313, that is, located on a side of the winding plate 9313 away from an axis of the high-voltage winding 930, so that the end-portion auxiliary member 93161 has a better fixing effect on the winding plate 9313, preventing displacement and dislocation of the winding plate 9313 during the winding of the wire and the injection of the high-voltage insulating layer. Depth of the recess 9317 is greater than or equal to a thickness of the end-portion auxiliary member 93161, which facilitates silicone rubber raw materials to wrap the end portion of the winding plate 9313 and the end-portion auxiliary member 93161 during the injection, and avoids the failure of the connection between the winding plate 9313 and the end-portion auxiliary member 93161 due to external forces. The end-portion auxiliary member 93161 is fixedly connected in the recess 9317 by an adhesive. The adhesive is a two-component high-temperature resistant epoxy adhesive, which may also be other adhesives, but it should be ensured that the adhesive enables firm bonding between the end-portion auxiliary member 93161 and the winding plate 9313, and is high-temperature resistant, so as to adapt to the wrapping of the high-voltage insulating layer around peripheries of the winding plate 9313 and the end-portion auxiliary member 93161 by high-temperature injection. In other embodiments, the end-portion auxiliary member may also completely match the recess in terms of size, so that the end-portion auxiliary member is snapped into the recess without being fixed by any adhesive.

In this embodiment, outer sides of two end portions of the winding plate 9313 are each provided with the end-portion auxiliary member 93161, so that the two ends of the winding plate 9313 are both fixed by the auxiliary member 9316, which can effectively maintain stable arrangement of the winding plate 9313. In other embodiments, alternatively, only outer side of one end portion of the winding plate is provided with the end-portion auxiliary member.

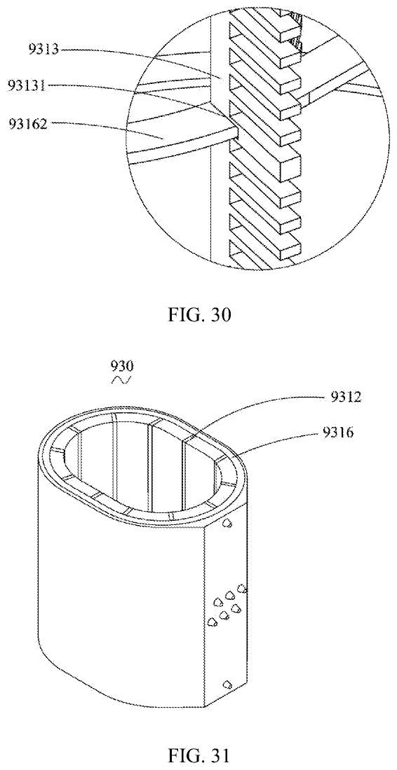

Referring to FIGS. 28 and 30 together, the auxiliary member 9316 further includes a middle auxiliary member 93162. When the winding plates 9313 define a cavity, a side surface for forming an inner wall of the cavity is defined as inner wall of the winding plate 9313. The middle auxiliary member 93162 is arranged on the inner walls of the winding plates 9313 without affecting the winding of the wire on the comb-tooth side of the winding plates 9313. Referring to FIG. 30, The inner wall of the winding plate 9313 is provided with a fourth slot 93131, and the middle auxiliary member 93162 is fastened in the fourth slot 93131, ensuring an effective connection between the middle auxiliary member 93162 and the winding plate 9313. Depth of the fourth slot 93131 match a ring width of the middle auxiliary member 93162, so that, after the middle auxiliary member 93162 is assembled with the winding plate 9313, an inner wall of the middle auxiliary member 93162 is flush with the inner wall of the winding plate 9313, preventing bending of the winding plate 9313 around the middle auxiliary member 93162 during the winding of the wire and the injection of the high-voltage insulating layer in a case that the depth of the fourth slot 93131 is less than the ring width of the middle auxiliary member 93162, or preventing the failure of fastening by the middle auxiliary member 93162 in a case that the depths of the fourth slot 93131 is greater than the ring width of the middle auxiliary member 93162.

In this embodiment, the auxiliary member 9316 includes two end-portion auxiliary members 93161 and one middle auxiliary member 93162, so that the winding plates 9313 can maintain stable positions during the winding of the wire and the injection of the high-voltage insulating layer, without displacement and dislocation, which prevents discharge caused by an insufficient insulation distance due to two coil sections getting extremely close to each other. In other embodiments, only the end-portion auxiliary member may be provided, or only the middle auxiliary member may be provided, or the auxiliary members may be spaced apart along the axial direction of the high-voltage winding, provided that the winding plates can be reinforced.

The auxiliary member 9316 is also made of glass fibers impregnated with epoxy resin. Several layers of glass fiber cloth impregnated with epoxy resin are superimposed to a certain thickness, and then molded and cured to form a ring-shaped glass steel sheet. The auxiliary member 9316 may be in a shape of a circular ring, an elliptical ring, or other rings. A thickness of the end-portion auxiliary member 93161 is required to be less than tooth heights of two ends of the winding plate 9313. When there is no requirement for the thickness of the middle auxiliary member 93162, the ring width of the middle auxiliary member 93162 is required to be less than widths of non-comb-tooth parts of the winding plate 9313, that is, an overall width of the winding plate 9313 minus the width of the winding groove 9314 of the winding plate 9313. Alternatively, when there is no requirement for the ring width of the middle auxiliary member 93162, the thickness of the middle auxiliary member 93162 is required to be less than tooth heights of the comb teeth in the middle of the winding plate 9313. Such arrangement prevents the influence on the winding of the wire on the winding plate 9313 due to occupation of the winding groove 9314 by the auxiliary member 9316.

Alternatively, the auxiliary member 9316 and the winding plate 9313 are separately molded and then bonded and fixed, or the auxiliary member 9316 and the winding plate 9313 are integrally formed.

The wire is wound circumferentially on outer peripheral surfaces of the winding plates 9313 to form the high-voltage coil. Then, high-temperature vulcanized silicone rubber is wrapped around the winding portion 9312, the high-voltage coil, and the auxiliary member 9316 by integral vacuum injection to form the high-voltage winding 930.

The present disclosure has at least the following beneficial effects. Different from the prior art, the high-voltage winding of dry-type transformer of the present disclosure includes a winding body, a high-voltage coil, and a high-voltage insulating layer made of injection-molded silicone rubber. Compared with the epoxy resin high-voltage insulating layer in the prior art, the high-voltage insulating layer made of injection-molded silicone rubber has the following advantages. 1) It has good fire resistance, low temperature resistance, aging resistance, and short circuit resistance, which can prolong the service life of the dry-type transformer. 2) The copper coil is easy to peel off from the silicone rubber, and thus, a material recovery rate is greater than 99%, which is more environmentally friendly. 3) On one hand, the silicone rubber elastomer can reduce incentives of partial discharge caused by mechanical vibration, and have an inhibitory effect on device discharge; moreover, a product of the silicone rubber under discharge is non-conductive silicon dioxide, which can effectively inhibit continuous deterioration of insulation. On the other hand, after assembly, various components can realize vibration-reducing connection through the silicone rubber elastomer, which can greatly reduce vibration and noise. 4) It can reduce operation losses of the transformer, and is more energy-efficient. 5) Silicone rubber has hydrophobicity and migration of hydrophobicity, and has good electric corrosion resistance and flame retardant effects. Silicone rubber is also used as an H-class insulating material with good insulating properties, and thus, it has good resistance to harsh environments and can be mounted indoors and outdoors. At the same time, the silicone rubber of the present disclosure is molded by integral high-temperature vulcanization injection. This process makes the high-voltage insulating layer more stable, with higher mechanical properties and better adhesion to the high-voltage coil and the winding body, which can effectively prolong the service life of the high-voltage insulating layer. Moreover, silicone rubber fillers for injection of the present disclosure are evenly distributed, which may not cause partial discharge of the dry-type transformer due to agglomeration of the fillers, so that the overall performance of the dry-type transformer is better.

The technical contents and features of the present disclosure are already disclosed as above. However, it should be appreciated that as guided by the creation idea of the present disclosure, those skilled in the art can make various modifications and improvements to the above structures and materials, including combinations of technical features individually revealed herein or sought for protection, obviously including other combinations of these features. These variations and/or combinations all fall within the technical field to which the present disclosure relate to and fall within the protection scope of claims of the present disclosure.

1. A winding body for a high-voltage winding, comprising:
a plurality of winding plates, each of the winding plates being provided with a plurality of winding grooves to form a plurality of comb teeth on the winding plate; and
at least one auxiliary member, the auxiliary member being ring-shaped, the winding plates being arranged along a circumferential direction of the auxiliary member, and the auxiliary member being fixedly connected to the winding plates.

2. The winding body according to claim 1,
wherein a height of the comb tooth along a length direction of the winding plate is defined as a tooth height, and tooth heights of the comb teeth in the middle of the winding plate and tooth heights of the comb teeth at two ends of the winding plate are both greater than tooth heights of the comb teeth in other parts of the winding plate.

3. The winding body according to claim 1,
wherein the winding body further comprises a supporting barrel, the supporting barrel being a hollow column, the winding plates are circumferentially evenly distributed on an outer peripheral surface of the supporting barrel, and a length direction of each of the winding plates is arranged along an axial direction of the supporting barrel.

4. The winding body according to claim 2,
wherein a first high comb-tooth region, a first low comb-tooth region, a second high comb-tooth region, a second low comb-tooth region, and a third high comb-tooth region are sequentially formed on the winding plate from an end of the winding plate to the other end of the winding plate in the length direction of the winding plate, the first high comb-tooth region and the third high comb-tooth region are arranged symmetrically with respect to the second high comb-tooth region, and the first low comb-tooth region and the second low comb-tooth region are arranged symmetrically with respect to the second high comb-tooth region.

5. The winding body according to claim 3,
wherein the auxiliary member is located on the outer peripheral surface of the supporting barrel, and the auxiliary member extends outward along a radial direction of the supporting barrel and surrounds the supporting barrel to form a ring-shaped.

6. The winding body according to claim 1,
wherein the plurality of winding plates or the auxiliary member is provided with a slot, and the winding plates and the auxiliary member are clamped and connected through the slot.

7. The winding body according to claim 1,
wherein the auxiliary member comprises a middle auxiliary member, and the middle auxiliary member is arranged on inner walls of the winding plates.

8. The winding body according to claim 1,
wherein the auxiliary member comprises an end-portion auxiliary member, and the end-portion auxiliary member is arranged on an outer side of an end portion of the winding plate.

9. The winding body according to claim 1,
wherein the winding body is made of a fiber-reinforced composite material.

10. (canceled)

11. The winding body according to claim 1,
wherein a plurality of auxiliary members is provided, the auxiliary members are spaced apart in an axial direction of the auxiliary member.

12. A high-voltage winding, comprising: the winding body according to claim 1; a high-voltage coil; and a high-voltage insulating layer,
wherein a wire is wound on the winding body to form the high-voltage coil, and the high-voltage coil is wholly wrapped with the high-voltage insulating layer.

13. The high-voltage winding according to claim 12,
wherein the wire comprises a first wire and a second wire, the first wire is wound from an end of the winding body to a middle of the winding body along a length direction of the winding plate, and the second wire is wound from the middle of the winding body to the other end of the winding body along the length direction of the winding plate.

14. The high-voltage winding according to claim 12,
wherein the high-voltage insulating layer fills a gap between the high-voltage coil and the winding body and is wrapped around two ends of the winding body, and the high-voltage insulating layer is injection-molded silicone rubber.

15. The high-voltage winding according to claim 14,
wherein the injection-molded silicone rubber is high-temperature vulcanized silicone rubber or liquid silicone rubber for injection.

16. The high-voltage winding according to claim 12,
wherein the high-voltage coil comprises a plurality of coil sections, the wire is wound in the winding grooves to cause the plurality of coil sections to be spaced apart along an axial direction of the high-voltage winding, and at least one of the coil sections is arranged between two adjacent comb teeth on the winding plate.

17. The high-voltage winding according to claim 16,
wherein each of the coil sections is reciprocally wound in layers along the axial direction of the high-voltage winding and is densely arranged on an outer peripheral surface of the winding body.

18. (canceled)

19. A dry-type transformer, comprising a core, a low-voltage winding, and the high-voltage winding according to claim 12, the low-voltage winding being sleeved outside the core, and the high-voltage winding being sleeved outside the low-voltage winding.

20. The dry-type transformer according to claim 19,
wherein the core is provided with four core clamps at an outer side of the core, and the core clamps are made of fiber-reinforced composite materials.

21. The dry-type transformer according to claim 20,
wherein the core clamps are compression-molded or pultruded from fiber materials impregnated with epoxy resin.

22. The dry-type transformer according to claim 19,
wherein the low-voltage winding comprises a copper coil and a low-voltage insulating layer, and the copper coil and the low-voltage insulating layer are alternately, and the low-voltage insulating layer is made of a SHS-P diphenyl ether prepreg material or a silicone rubber film.

23. (canceled)

24. (canceled)
